(19) United States
(12) Patent Application Publication
(10) Pub. No.: US 2024/0073763 A1
(43) Pub. Date: Feb. 29, 2024

(54) METHOD AND APPARATUS FOR NON-TERRESTRIAL NETWORK MOBILITY IN WIRELESS COMMUNICATION SYSTEM

(71) Applicant: SAMSUNG ELECTRONICS CO., LTD., Suwon-si (KR)

(72) Inventors: Chadi KHIRALLAH, Staines (GB); Aby Kanneath ABRAHAM, Bangalore (IN)

(21) Appl. No.: 18/448,038

(22) Filed: Aug. 10, 2023

(30) Foreign Application Priority Data
Aug. 10, 2022 (IN) 202231045580
Jul. 6, 2023 (GB) 2310452.4

(51) Int. Cl. H04W 36/08; H04W 36/00; H04W 36/32

(52) U.S. Cl. CPC H04W 36/083; H04W 36/0061; H04W 36/0088; H04W 36/322; H04W 84/06

(57) ABSTRACT

The disclosure relates to a 5G or 6G communication system for supporting a higher data transmission rate. Disclosed herein is a method of a user equipment (UE) for non-terrestrial network (NTN) the method comprising: receiving, from a network, assistance information related to the non-terrestrial network (NTN) for cell reselection; and performing a measurement on a neighbouring cell for the cell reselection based on the assistance information, wherein the assistance information includes ephemeris information on the neighbouring cell. In the embodiments, the assistance information is included in a system information block (SIB) broadcast by at least one of a serving cell or the neighbouring cell.

### CROSS-REFERENCE TO RELATED APPLICATIONS

This application is based on and claims priority under 35 U.S.C. § 119 to Indian Patent Application Serial No. 202231045580 filed on Aug. 10, 2022, in the Indian Patent Office, and GB Patent Application Serial No. 2310452.4, which was filed on Jul. 6, 2023, the entire disclosure of each of these applications is incorporated herein by reference.

### BACKGROUND

### 1. Field

The present disclosure relates to enhancements for non-terrestrial network mobility in 5G New Radio (NR) systems, and in particular methods and apparatus for providing enhancements to non-terrestrial network mobility in 5G NR systems.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement CG mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC); and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed. Reality) and the like, 5G performance improvement and complexity reduction by utilizing Artificial Intelligence (AI) and Machine Learning (ML), AI service support, metaverse service support, and drone communication

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz hand signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Wireless or mobile (cellular) communications networks in which a mobile terminal (UE, such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks. One such new architecture focusses on the use of non-terrestrial networks (NTN) as part of the radio access network (RAN). NTN includes the provision of a RAN via satellites and may also include high-altitude platforms and air-to-ground (ATG) scenarios. However, the use of NTN, especially when provided via satellites presents a number of challenges with respect to cell selection and re-selection and mobility between NTNs and between NTN and terrestrial networks (TN).

According to 3GPP TS 38.300, Non-Terrestrial Networks (NTN) provide NTN New Radio (NR) access to the User Equipment (UE) by means of a NTN payload, a NTN Gateway, a service link between NTN payload and UE, and a feeder link between NTN Gateway and NTN payload. Three types of service links are supported:

Earth-fixed: provisioned by beam(s) continuously covering the same geographical areas all the time (e.g. the case of geo-stationary orbit (GSO) satellites)

Quasi-Earth-fixed: provisioned by beam(s) covering one geographic area for a limited period and a different geographic area during another period (e.g. the case of non-GSO (NGSO) satellites generating steerable beams)

Earth-moving: provisioned by beam(s) whose coverage area slides over the Earth surface (e.g. the case of NGSO satellites generating fixed or non-steerable beams)

With NGSO satellites, the 5G NR base station (i.e. gNB) can provide either quasi-Earth-fixed cell coverage or Earth-moving cell coverage, while a gNB operating with a GSO satellite can provide Earth fixed cell coverage. However, the use of NGSO satellites presents particular challenges due to the non-Earth-fixed cell coverage i.e. due to the moving nature of cells provided by NGSO satellites.

With respect to mobility in RRC_IDLE and RRC_INACTIVE modes, the network may broadcast multiple Tracking Area Codes (TAC) per PLMN in a NR NTN cell. A TAC change in the System Information (SI) is under network control, i.e. it may not be exactly synchronised with real-time illumination of beams on ground. Furthermore, NTN ephemeris is divided into serving cell's satellite ephemeris and neighbouring cell's satellite ephemeris.

With respect to UE measurements and NTN, a UE may report service link propagation delay differences between a serving cell and neighbour cells as the assistance information for the adjustment of Synchronisation Signal Block (SSB)-based Radio Resource Management (RRM) measurement time configurations (SMTCs) in connected mode.

In the quasi-earth fixed cell scenario, a UE can perform time-based and. location-based measurement in RRC_IDLE/RRC_INACTIVE, where

The timing and location information associated to a cell are provided via system information

Timing information refers to the time when the serving cell is going to stop serving a geographical area

Location information refers to the reference location of serving cell

Measurement rules for cell re-selection with timing information and location information is specified in section 5.2.4.2 of 3GPP TS 38.304 v 17.1.0, where this is reproduced below and the definition of terms can be found in this document.

```
Following rules are used by the UE to limit needed measurements:
    If the serving cell fulfils Srxlev > S_{IntraSearchP} and Squal > S_{IntraSearchQ}:
      If distanceThresh is broadcasted in SIB19, and if UE supports location-based
      measurement initiation and has obtained its location information:
        If the distance between UE and the serving cell reference location is shorter than
        distanceThresh, the UE may not perform intra-frequency measurements;
        Otherwise, the UE shall perform intra-frequency measurements;
      Otherwise, the UE may not perform intra-frequency measurements;
    Otherwise, the UE shall perform intra-frequency measurements.
    The UE shall apply the following rules for NR inter-frequencies and inter-RAT
    frequencies which are indicated in system information and for which the UE has priority
    provided as defined in 5.2.4.1:
      For a NR inter-frequency or inter-RAT frequency with a reselection priority higher
      than the reselection priority of the current NR frequency, the UE shall perform
      measurements of higher priority NR inter-frequency or inter-RAT frequencies
      according to TS 38.133 [8].
      For a NR inter-frequency with an equal or lower reselection priority than the
      reselection priority of the current NR frequency and for inter-RAT frequency with
      lower reselection priority than the reselection priority of the current NR frequency:
        If the serving cell fulfils Srxlev > S_{nonIntraSearchP} and Squal > S_{nonIntraSearchQ};
          If distanceThresh is broadcasted in SIB19, and if UE supports location-based
          measurement initiation and has valid UE location information:
            If the distance between UE and the serving cell reference location is shorter
            than distanceThresh, the UE may choose not to perform measurements of
            NR inter-frequency cells of equal or lower priority, or inter-RAT frequency
            cells of lower priority;
            Otherwise, the UE shall perform measurements of NR inter-frequency cells
            of equal or lower priority, or inter-RAT frequency cells of lower priority
            according to TS 38.133 [8];
          Otherwise, the UE may choose not to perform measurements of NR inter-
          frequency cells of equal or lower priority, or inter-RAT frequency cells of lower
          priority;
        Otherwise, the UE shall perform measurements of NR inter-frequency cells of
        equal or lower priority, or inter-RAT frequency cells of lower priority according to
        TS 38.133 [8].
    If the UE supports relaxed measurement and relaxedMeasurement is present in SIB2, the
    UE may further relax the needed measurements, as specified in clause 5.2.4.9.
If the t-Service of the serving cell is present in SIB19, UE shall perform intra-frequency, inter-
frequency or inter-RAT measurements before the t-Service, regardless of the distance between
UE and the serving cell reference location or whether the serving cell fulfils Srxlev >
SIntraSearchP and Squal > SIntraSearchQ, or Srxlev > SnonIntraSearchP and Squal >
SnonIntraSearchQ and the exact time to start measurement before t-Service is up to UE
implementation. UE shall perform measurements of higher priority NR inter-frequency or
inter-RAT frequencies according to TS 38.133 [8] regardless of the remaining service time of
the serving cell (i.e. time remaining until t-Service).
NOTE:
When evaluating the distance between UE and the serving cell reference location, it's up to UE implementation to obtain UE location information.
```

In view of the above, enhancements to Next Generation (NG)-RAN based NTN are sought according to the following assumptions with implicit compatibility to support HAPS (High Altitude Platform Station) and ATG (Air To Ground) scenarios:

GSO (Geo Synchronous Orbit) and NGSO (Non Geo Synchronous Orbit). NGSO includes Low Earth Orbit (LEO) and Medium Earth Orbit (MEO).

Earth fixed tracking area. Earth fixed & Earth moving cells fix NGSO.

FDD mode.

UEs with GNSS (Global Navigation Satellite Systems) capabilities.

In particular, enhancements to NTN-TN and NTN-NTN measurement/mobility and service continuity are sought, including
1) For NTN-NTN mobility, specify cell reselection enhancements for earth moving cell. The timing-based and location-based cell reselection for quasi-earth fixed cell in Rel-17 (3GPP TS 38.304 v 17.1.0) can be considered as the starting point.
II) Specify NTN-NTN handover enhancement for RRC_CONNECTED UEs in the quasi-earth-fixed cell and earth-moving cell to reduce signalling overhead.
III) Specify cell reselection enhancements for RRC_IDLE/INACTIVE UEs to reduce UE power consumption (NTN-TN mobility is prioritized).
IV) Specify enhancement to Xn[/NG] signalling to support feeder link switch-over, CHO, e.g. exchange of information between gNBs.

The present disclosure concentrates on providing enhancements relating to I)-III) above.

The content of the following documents is referred to below and/or their content provides useful background information that the following disclosure should be considered in the context of.

RP-221819, Revised WID: NR NTN (Non-Terrestrial Networks) enhancements.

R2-2206509, Corrections to stage 2 for NR NTN

3GPP TS 38.413 v17.1.1, Technical Specification Group Radio Access Network; NG-RAN; NG Application Protocol (NGAP)

3GPP TS 38.331 v17.1.0, Technical Specification Group Radio Access Network; NR; Radio Resource Control (RRC) protocol specification

3GPP TS 3.501 v 17.5.0

### SUMMARY

It is an aim of certain examples of the present disclosure to provide enhancements to cell selection/reselection for non-terrestrial networks (NTN) and/or to reduce signalling overheads and power consumption for cell selection/reselection involving NTN.

The present invention is defined in the independent claims. Advantageous features are defined in the dependent claims.

Accordingly, the embodiments herein provide a method of a user equipment (UE) for non-terrestrial network (NTN) the method comprising: receiving, from a network, assistance information related to the non-terrestrial network (NTN) for cell reselection; and performing a measurement on a neighbouring cell for the cell reselection based on the assistance information, wherein the assistance information includes ephemeris information on the neighbouring cell. In the embodiments, the assistance information is included in a system information block (SIB) broadcast by at least one of a serving cell or the neighbouring cell.

In the embodiments, the UE receives, from the network, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Accordingly, the embodiments herein provide a method of a network entity, the method comprising: transmitting, to a user equipment (UE), assistance information related to the non-terrestrial network (NTN) for cell reselection; wherein the assistance information is used to perform a measurement on a neighbouring cell for the cell reselection, and wherein the assistance information includes ephemeris information on the neighbouring cell.

In the embodiments, the assistance information is included in a system information block (SIB) broadcast by at least one of a serving cell or the neighbouring cell.

In the embodiments, the network entity transmits, to the UE, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Accordingly, the embodiments herein provide a user equipment (UE) for non-terrestrial network (NTN), the UE comprising: a transmitter; a receiver; and at least one processor coupled to the transmitter and the receiver, and configured to: receive, from a network, assistance information related to the non-terrestrial network (NTN) for cell reselection, and perform a measurement on a neighbouring cell for the cell reselection based on the assistance information, wherein the assistance information includes ephemeris information on the neighbouring cell.

In the embodiments, the assistance information is included in a system information block (SIB) broadcast by at least one of a serving cell or the neighbouring cell.

In the embodiments, the at least one processor is configured to receive, from the network, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Accordingly, the embodiments herein provide a network entity, the network entity comprising: a transmitter; a receiver; and at least one processor coupled to the transmitter and the receiver, and configured to: transmit, to a user equipment (UE), assistance information related to the non-terrestrial network (NTN) for cell reselection, wherein the assistance information is used to perform a measurement on a neighbouring cell for the cell reselection, and wherein the assistance information includes ephemeris information on the neighbouring cell.

In the embodiments, the assistance information is included in a system information block (SIB) broadcast by at least one of a serving cell or the neighbouring cell.

In the embodiments, the at least one processor is configured to transmit, to the UE, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1a and 1b illustrate a schematic diagram of a UE NTN capability message and its contents in accordance with the present disclosure.

FIG. 2 illustrates a schematic diagram of a UE NTN capability message and its contents in accordance with the present disclosure.

FIGS. 3a and 3b illustrate schematic diagrams of example NTN mobility scenarios.

FIG. 4 illustrates a schematic diagram of a network entity in accordance with an example of the present disclosure.

### DETAILED DESCRIPTION

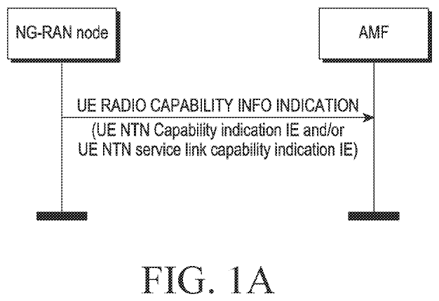

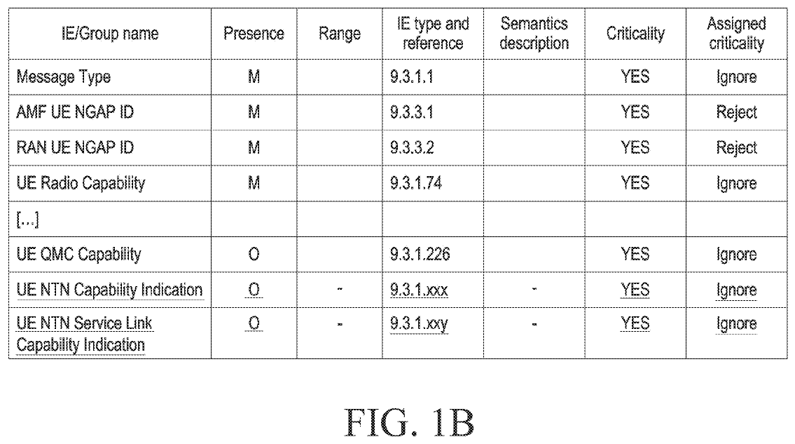

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Examples in accordance with the present disclosure will now be described in the context of a 5G wireless communication network, comprising for example one or more mobile terminals, a RAN, and a core network. A 5G wireless communications network may also be considered to comprise a mobile terminal and a network, where the network is includes one or more network entities that form the RAN and/or core network (CN). However, it will be understood that the present disclosure is not limited to only 5G system but may be applied to other wireless communication systems in which satellite communications are available. Consequently, references to particular 3GPP constructs in certain examples should not be understood as limiting the ability of examples of the present disclosure to be applied to other wireless communication networks. The approaches set out below and in the claims are appliable to the use of non-terrestrial networks in any form with any type of UE or mix of UEs, such as IoT NTN for example and well as conventional UEs.

NGSO (e.g. LEO satellites) move at very high speed (e.g. over 20000 km/h), so it is expected that the service links (e.g. Earth moving cells) would move at the same high speed of satellites. This may result in a discontinuous User Equipment (UE) coverage in New Radio (NR) Non-Terrestrial Networks (NTN). Moreover, other parameters (e.g. UE velocity, location, trajectory, and/or elevation/altitude, or other) could further add to the problem of coverage in NR NTN. Accordingly, the following problems may occur:

Measurement failure: a UE may not be able to perform measurements (e.g. cell selection, cell re-selection) on serving and/or neighbouring cells, due to the movement of UE and the desired cell

Handover failure: current handover decision are based on a trigger threshold on the received signal quality of the target (handover to) cell (i.e. cell selection criterion S and re-selection criterion R). However, such a scheme would result in high rate of handover failure due to increased probability of handover interruption (i.e. handover is not completed) resulting from cell movement and UE getting out of coverage during the handover process.

Given these potential problems, one or more of the following aspects should be addressed.
1) How to perform NTN-NTN mobility, including cell reselection enhancements for earth moving cell?
2) How to perform cell reselection (i.e. including measurements) considering UE type and/or service link capability?
3) How to perform cell reselection (i.e. including measurements) considering UE mobility and Satellite mobility?
4) How to specify cell reselection enhancements for RRC_IDLE/INACTIVE UEs to reduce UE power consumption (NTN-TN mobility is prioritized)?

The examples and/or functionality set out below may be configured separately or in combination unless stated as being incompatible. Consequently, although various examples are described separately, they should not be construed as separate embodiments that cannot be combined.

In accordance with the present disclosure, a UE may be configured with different cell selection/re-selection parameters and/or candidate/available NTN cells based on a type of cell (i.e. service link type), availability of the cell with respect to the UE, location and/or movement of the UE and cells, and/or the capability of the UE (e.g. the type of service links supported). Information on the types of NTN cells may be provided to a UE by each cell (e.g. through broadcast system information signalling and/or dedicated RRC messages), may be pre-configured at the UE, or may be provided through an existing network connection (e.g. though the current serving cell). The information on cell types includes information on the serving cell and/or neighbouring cells and may for example specifying one or more of whether a cell is an Earth-moving, quasi-Earth fixed, of Earth fixed cell or not for example. The other information on which cell selection/reselection may be based may be pre-configured or received from the network or an entity thereof, the cells themselves, the serving cell (i.e. serving gNB), or calculated by the UE. Throughout this disclosure, although only cell selection may sometimes be referred to, this includes both (initial) cell selection and cell reselection.

NTN Cell List

In a first approach, one or more cell lists upon which cell re-selection may take place are configured at the UE, where the cell list may be configured by the network or an entity thereof (e.g. gNB, AMF, other network entities) or by the UE itself based on obtained cell information.

When configured by the network or an entity thereof, the network may configure a list of NTN and/or TN cells (e.g. for cell reselection) that are suitable for the UE measurements and/or cell (re-) selection capability based on one or more the cell type (e.g. TN, NTN Earth-fixed, NTN Quasi-Earth-fixed, NTN Earth-moving), UE type (i.e. category) and service link capabilities (e.g. TN, NTN Earth-fixed, NTN Quasi-Earth-fixed, NTN Earth-moving). The capabilities of the UE may have been previously reported to the network, where such capability reporting is described in more detail below. With respect to the type/content of the lists, the network (e.g. a gNB) may for example configure one or more of:

Allowed cell list (e.g. NTN Earth-fixed and/or NTN Quasi-Earth-fixed, TN) for UEs capable of performing normal measurements and/or cell (re)selection and/or handover. In an one example, an allowed cell list may be provided per cell type (for e.g. TN, NTN Earth-fixed, NTN Quasi-Earth-fixed, NTN Earth-moving etc.). In another embodiment an allowed cell list contains physical cell ID (PCI) of the allowed neighbor cells.

Forbidden cell list (e.g. NTN Earth-moving) for UEs that are not capable of performing fast measurements and/or cell (re)selection and/or handover to Earth-moving cells. In one example, a forbidden cell list may be provided per cell type (for e.g. TN, NTN Earth-fixed, NTN Quasi-Earth-fixed, NTN Earth-moving). In another example a forbidden cell list contains PCI of the forbidden neighbor cells.

A list of neighbor cells and their types (e.g. TN, NTN Earth-moving, NTN Earth-fixed or NTN Quasi-Earth-fixed). A UE may be provided with an indication that cells are of type Earth-moving cells, or a list of cells may be provided indicating that cells are of type Earth-fixed or Quasi-Earth-fixed cells. In one example, the cell list contains PCI of the neighbor cells and the serving cell. In another example, the cell type for NTN cells are identified by ephemeris provided in system information (such as SIB19) and/or dedicated signalling.

The gNB may provide the above lists per frequency in broadcast signalling and/or in the dedicated signalling. In some examples, an indication that all available cells may be considered for selection/reselection may be provided instead of a list, for instance if no restrictions result from the capabilities of the UE (e.g. when a UE supports Earth moving cells). Each of the cells lists described above may also be at least partially based on other selection criteria, for example based on a priority or loading of cells.

UEs may consider the neighbor cells for reselection (i.e. perform measurements for reselection or perform cell reselection evaluation) based on one or more of the above lists. The UE's consideration of cells may be limited to the list or may be further reduced if the list has not been formed based a criteria relevant to the UE. For example, the UE may consider the neighbor cells for reselection based on the type of the cells, such that, if the UE is not capable of camping on Earth-moving cells, the UE may not reselect to the neighbor cells, which are indicated as Earth-moving cells.

In another example, a UE may apply different type of cell reselection based on the configured list. For example, if the type of the cell is Earth-moving cell, the UE may perform normal cell reselection (for e.g. cell reselection not specific for NTN) and may not perform distance and location based cell reselection. In another example, the network may inform UE the type of cell reselections possible for a specific type of cell and a specific type of UE.

In addition to the identification of cells and/or their types in the above-detailed lists, the network may provide any of following further information to the UE in such lists, on a serving cell, neighboring cell, and/or per cell or group of cells basis. However, this additional information may also be provided in system information or via other mechanisms.

Timer(s) indicating the time a cell will appear (i.e. become available for measurement and/or service). This information may be provided about neighbor cells by the serving cell through system information message (e.g. included in SIB19. t-Appear).

Timer(s) indicating the time a cell will disappear (i.e. become not suitable for measurement and/or service). This information may be provided about neighbor cells and the serving cell by the serving cell through system information message (e.g. included in SIB19, t-Disappear)

Velocity and/or trajectory of the serving cell and neighbor cells (e.g. cellVelocity, cellTrajectory)

Current location of the serving and neighbor cells (e.g. cell reference point, and/or other).

If the network doesn't provide the timers and provides only location and velocity, the UE may calculate the timers for appearance and disappearance from the velocity and location. Similarly if the time of appearance and/or disappearance is provided, the UE may calculate the cell velocity.

In some examples, based on the above information a relative velocity between the UE and Earth-moving cell will be used by the UE for calculating the location/timing for applying the timing based and/or location based cell reselection.

For example, if distanceThresh is broadcasted in SIB19, and if the UE supports location-based measurement initiation for NTN Earth-moving cells and has valid UE location information, for a NTN Earth-moving cell, the UE may calculate the distance between the cell and the UE using the relative velocity between the UE and the Earth-moving cell. If the distance is above distanceThresh, the UE may perform intra frequency measurements. If the distance is above distanceThresh and the serving cell fulfils Srxlev>SnonIntraSearchP and Squal>SnonIntraSearchQ, the UE may perform equal or lower priority inter frequency measurements.

In another example, if the UE is moving away from a NTN Quasi-Earth-fixed low priority neighbor or an NTN Earth-moving low priority neighbor Cell is moving away from the UE, or the UE and NTN low priority neighbor Earth-moving cell and the UE are moving away from each other and the neighboring cell has not fulfilled neighbor cell reselection evaluation criteria in section 5.2.4.5 of TS 38.304 v17.1.0 (Squal>ThreshX, LowQ, or Srxlev>ThreshX, LowP as the case may be), the UE may not perform cell reselection measurements for that cell. If there is an allowed list broadcasted as set out above, and all the cells needn't be measured as mentioned above, the UE may not perform cell reselection measurements for that frequency.

As noted above, a UE may support location-based measurement initiation for NTN Earth-fixed, NTN Quasi-Earth-fixed, but not for NTN Earth-moving cells, and thus the lists may be configured accordingly. The UE may indicate its capability to the network in RRC signalling.

The speed of the Earth-moving cell may be used for deciding the mobility state of the UE for performing cell reselection measurements and evaluation. Alternatively, the relative velocity between the UE and the Earth-moving cell may be used for deciding the mobility state of the UE for performing cell reselection measurements and evaluation.

The network may also include the following information in the above-detailed lists, on a serving cell, neighboring cell, and/or per cell or group of cells basis, where this information may be used to determine mobile information of the UE and for performing cell reselection measurements and evaluation. This additional information may also be provided in system information or via other mechanisms.

Satellite (e.g. beam, cell) mobility characteristic/parameters (e.g. velocity, direction or movement, elevation angle, altitude, other)

All the above information may be provided to the UE via dedicated signalling and/or system information broadcast (e.g. periodic and/or on-demand).

When the same frequency is used by Earth-moving cells and other NTN cells (i.e. Earth-fixed cells, Quasi-Earth-fixed cells, etc.) or TN cells, different cell reselection thresholds (e.g. for Reference Signal Received Power/Reference Signal Receive Quality/Received Signal Strength Indicator (RSRP/RSRQ/RSSI)) may be used for Earth-moving cells within the same frequency, where these thresholds may be added in the list of cells for example. In some instances a scaling factor may be provided to the UEs for Earth-moving cells and the UE applies the scaling factor for the measurements. For example, a scaling factor may be provided for Treselection for Earth-moving cells. Alternatively, a different value for Treselection (Treselection−earthmoving) may be provided for Earth-moving cells. The UE applies the Treselection+scaling factor or Treselection−earthmoving for the Earth-moving cells. For other cells in the same frequency, the UE may not apply the scaling factor depending on their type and/or service link type.

In some examples, each of the type of cells may be associated with different thresholds and different offsets. For example, Earth-moving cells may have different thresholds and different offsets compared to other types for low priority, equal priority, high priority reselections etc. Similarly for other types. In other examples, the distance thresholds for each of the type of cells can be different for distance based cell reselection.

In some examples, the network may request information on UE mobility (e.g. velocity, acceleration, trajectory, elevation angle, altitude, and/or other information), using a UEInformationRequest message for instance, where the UEInformationRequest message may include fields velocityRequest-r18, trajectoryRequest-r18, and/or altitudeRequest-r18 for example. Details of a UEInformationRequest message are set out below. This information may be used by the network to configure the lists or other cell selection/reselection parameters.

UEInformationRequest message

```
UEInformationRequest-v1800-IEs ::= SEQUENCE {
[ ... ]
    velocityRequest-r18   ENUMERATED {true}  OPTIONAL, -- Need N
    trajectoryRequest-r18  ENUMERATED {true}  OPTIONAL, -- Need N
    altitude Request-r18  ENUMERATED {true}  OPTIONAL, -- Need N
[ ... ]
}
velocityRequest-r18
This field is used to request UE to report its velocity information.
trajectoryRequest-r18
This field is used to request UE to report its trajectory information.
altitudeRequest-r18
This field is used to request UE to report its altitude information.
```

In turn, the UE may use the UEInformationResponse message to report its mobility information to the network, details of which are set out below.

```
UEInformationResponse-v1800-IEs ::=  SEQUENCE {
      velocityRequest-r18  OCTET STRING  OPTIONAL,
      trajectoryRequest-r18  OCTET STRING  OPTIONAL,
      altitude Request-r18   ENUMERATED {true}   OPTIONAL,
  [ ... ]
}
```

As noted above, satellite information (e.g. satellite assistance information) may be provided in an SIB19 information element, details of which are set out below. This assistance information may also include cell location information (e.g. a current location and/or a cell reference point).

-- ASN1START
-- TAG-SIB19-START
SIB19-r18 ::= SEQUENCE {
[ ... ]
t-Appear-r18 INTEGER (0..549755813887) OPTIONAL, -- Need
R
t-Disappear-r18 INTEGER (0..549755813887) OPTIONAL, --
Need R
cellVelocity-r18 INTEGER (0..xxx)
OPTIONAL, -- Need R
cellTrajectory-r18 INTEGER (0..xxx)
OPTIONAL, -- Need R
[ ... ]
ntn-NeighCellConfigList-r18 NTN-NeighCellConfigList-r18 OPTIONAL,
-- Need R
[ ... ]
}
NTN-NeighCellConfigList-r18 ::= SEQUENCE (SIZE(1 .. maxCelINTN)) OF NTN-
NeighCellConfig-r18
NTN-NeighCellConfig-r18 ::= SEQUENCE {
[ ... ]
t-Appear-r18 INTEGER (0..549755813887) OPTIONAL, -- Need
R
t-Disappear-r18 INTEGER (0..549755813887) OPTIONAL, --
Need R
cellVelocity-r18 INTEGER (0..xxx)
OPTIONAL, -- Need R
cellTrajectory-r18 INTEGER (0..xxx)
OPTIONAL, -- Need R
[ ... ]
}

SIB19 field descriptions

t-Appear
indicating the time a cell will appear (i.e. become available for measurement and/or service). This
information may be provided about serving cell and/or neighbor cells by the serving cell through
system information message.
t-Disappear
indicating the time a cell will disappear (i.e. become not suitable for measurement and/or service).
This information may be provided about serving cell and/or neighbor cells by the serving cell
through system information message.
cellVelocity
Provides information on serving cell and neighbour cells velocity.
cellTrajectory
Provides information on serving cell and neighbour cells trajectory.

UE Capability Reporting

In order for the lists described above to be configured by the network, the network may acquire information on the NTN capabilities of the UE so that cells that are able to be selected by the UE and upon which measurements may be performed are appropriately determined. Methods for providing UE capability information to the network include

The UE capability for NTN operation may be defined and/or reported as generic NTN capability. For example, a UE may report that it is capable of NTN operation.

The UE capability for NTN operation may be defined and/or reported as per Service Link type (e.g. Earth-fixed, Quasi-Earth-fixed, and/or Earth-moving) NTN capability (e.g. namely service link capability, or other naming). For example, a UE may report the service link type(s) of NTN it supports.

The UE may include the information in a UE capability response. The network (e.g. gNB) may configure the UE with dedicated cell reselection information based on the UE NTN capability and service link type capability and/or information related to UE mobility. The NTN capability information may also be reported periodically or if/when it changes, for example, when NTN capability or particular service link capability is enabled/disabled at the UE.

More generally, the UE may indicate its NTN capability and/or service link capability to the Network directly to CN or via NG-RAN. For example, the UE may indicate its NTN capability and/or service link capability directly to CN, e.g. using existing and/or newly defined NAS signaling/messages. The CN may forward this information to NG-RAN (e.g. via existing and/or newly defined NG signaling/messages), or the NG-RAN may retrieve the information from CN (e.g. via existing and/or newly defined NG signaling/messages).

Alternatively, the NG-RAN may receive information related to UE NTN capability and/or service link capability from the UE via RRC signaling/messages (using existing and/or newly defined signaling/messages). The UE may provide this information to the NG-RAN using and existing or a newly defined IE (e.g. UE NTN Capability IE, UE Service Link Capability Indication IE, or another naming), included in RRC signaling/messages. The NG-RAN may send/forward this information to the CN (e.g. AMF) using for example, the UE RADIO CAPABILITY INTO INDICATION message, as shown in FIGS. 1a and 1b where additions to the message (e.g. new information Elements (IE)) are underlined.

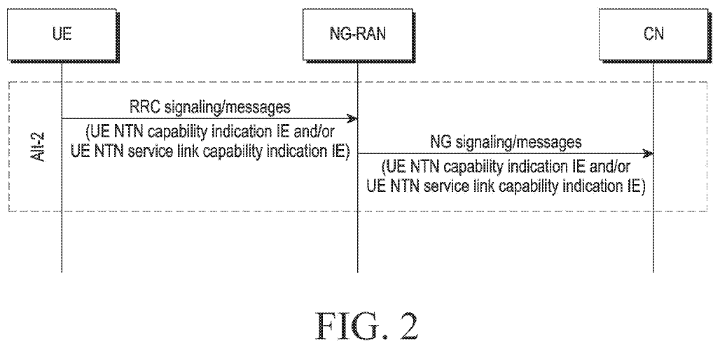

Alternatively, a newly defined RRC and/or NG signalling/messages may be used, as illustrated by FIG. 2, where a UE is providing info on UE NTN Capability Indication and/or UE NTN Service Link Capability Indication to the network (NG-RAN and/or CN) included in existing or a newly defined RRC and NG signalling/messages.

Other Aspects of UE Cell List Handling

In some examples, a UE may be provided by the network a list of all NTN cells which the UE may measure and/or perform cell (re)selection, where the list may be based on UE type and/or service link capability as set out above, such that it may include information on cells type (i.e. service link type), velocity, timers etc. Alternatively, the list may merely include all available cells without regard to UE capabilities. The UE may then decide on cells to measure considering NTN cell conditions (service link type and/or mobility characteristics, other) and UE capability (i.e. service link capability) and/or other conditions/scenarios (e.g. UE velocity, trajectory, altitude, other). Velocity types may also include NR NTN cell (service link) velocity, which is the speed of moving satellite coverage (e.g. beam, cell) That is, different UEs would measure different NUN cells and perform cell (re)selection accordingly even though they may receive the same cell list.

In another example, a network is configured not to provide a UE with any of the NTN lists described above or an NTN list is not received by the UE and/or the network does not provide the UE with cell mobility characteristics and/or timing information of NR NTN cells. In such a situation, the UE may attempt measurements and/or cell (re)selection on all NR NTN cells. For example, the UE performs measurements and/or cell reselection evaluation considering UE NTN capability (e.g. service link capability=Earth-moving) and NTN cell type (i.e. Quasi-Earth-moving and/or Earth-moving), and/or other UE mobility conditions. In another example, the UE performs measurements and/or cell reselection evaluation without considering the UE NTN capability or UE moving conditions (e.g. UE movement direction relative to cell movement, or other). This approach may also be used as a fall-back position is NTN cell information has not been received or insufficient information has not been received. In some examples, UE selection/reselection behaviour may be based on information received from the individual cells (e.g. in system information), such as service link and movement parameters. The UE may also base UE selection/reselection behaviour on its mobility information or configurations, such as whether particular NTN capabilities are enabled/disabled.

In view of above described NTN lists and the dependence of UE behaviour on the presence of NTN cell lists, below is an example formal description of the allowed and forbidden NTN lists and UE behaviour.

allowedNTNCellsList
If present, the UE can only measure and/or camp on the cells indicated in this list. Otherwise,
if this parameter is absent, the UE may measure and/or camp on any NTN cell considering
UE NTN capability (i.e. service link capability = {Earth-fixed, Quasi-Earth-moving and/or
Quasi-Earth-moving}).
forbiddenNTNCellsList
If present, the UE is not allowed to measure and/or camp on the cells indicated in this list.
Otherwise, if this parameter is absent, the UE may measure and/or camp on any NTN cell
considering UE NTN capability (i.e. service link capability = { Earth-fixed, Quasi-Earth-
moving and/or Quasi-Earth-moving }).

Application to NTN Enhancements

The approaches set out above may be used to address one of more of aspects 1) to 4) and thus enhance NTN mobility and reselection, as detailed below.

With respect to how to perform NTN-NTN mobility, including cell reselection enhancements for earth moving cell, the reporting of UE capabilities to the network (e.g. RAN, CN, another internal and/or external network entity, and/or network function), the provision of additional cell information to the UE, and/or the provision of NTN lists may be used address this aspect.

In a first implementation, an indication of UE NTN capability in terms of support for different NTN cells types as described above can be introduced in order to provide UE capability information to the network. Subsequently, based on the UE capability information and potential further information (e.g. UE subscription information), the network may assign a suitable list of NTN cells for the UE in dedicated signalling, thus enhancing NTN cell selection.

In a second implementation, timing information on Earth-moving cells cell (serving and/or neighbor cells), e.g. time cell appear and/or disappear from UE coverage, can be provided to the UE. Then UE can then use timing information and information on Satellite speed, altitude, location, elevation angle, trajectory, etc., to decide on feasibility of measuring and/or reporting measurement for Earth-moving cell. Selection criteria based on this information may be preconfigured or received from the network.

Alternatively or additionally, network configured lists specifying allowed or forbidden cells may be used to address the aspect how to perform NTN-NTN mobility, including cell reselection enhancements for earth moving cell.

For instance, the network may configure a list of cells suitable for UE NTN capability/type and/or UE conditions/scenario (e.g. UE mobility, other). In particular, the network may assign list(s) of NR NTN cells of one or multiple service link types (i.e. earth-fixed, quasi-earth fixed and/or earth-moving NTN cells) to the UE. For example, the list maybe named, “allowedNTNCellsList”, “forbiddenNTNCellsList”, or other suitable naming, and may be formed considering UE type information, such that the NW may assign allowed NTNCellsList that include fixed and/or quasi-earth fixed cells, and forbiddenNTNCellsList list including earth-moving cells.

The first and second implementations may also be used for enhancing or prioritising TN-NTN and/or NTN-TN mobility. For example, the lists may be configured to prioritise certain TN cells or NTN cells according to the current requirements of the network and/or UE. In other words, the various approaches and implementations set out above may be applied to any aspects of mobility where NTN are involved.

With respect to how to perform cell reselection (i.e. including measurements) considering UE type and/or service link capability, and how to perform cell reselection (i.e. including measurements) considering UE mobility and Satellite mobility, network configured lists may be used to address these aspects. Appropriate configuration of the NTN selection/measurement procedure at the may also achieve these aims. For example, measurements on particular NTN cells may be performed if they are of a certain type and/or their characteristics meet certain threshold, that may be related to time, distance, or mobility for example.

For example, presuming that UE NTN capability information is known by the network (e.g. via the use of the previously described capability reporting), the network may configure the list(s) provided to the UE based on UE capabilities (i.e. UE type and/or service link capability) and/or configured the list(s) based on the UE mobility information and satellite mobility information. The lists may then be provided in one or more of the forms described above, such as “allowedNTNCellsList”, “forbiddenNTNCellsList”.

Alternatively, the UE may utilise assistance information that has been provided from the network via system information broadcast and/or dedicated signalling in order to determine which NTN cell to consider for measurement, either following the receipt of a cell list or in the absence of a cell list.

With respect to how to specify cell reselection enhancements for RRC_IDLE/INACTIVE UEs to reduce UE power consumption (NTN-TN mobility is prioritized), the network can configure the lists to prioritise TN ahead of NTN. Alternatively, as noted above, configurations for the prioritising of certain TN or NTNs may be made at the UE either unilaterally or in response to configuration information received from the network. Such prioritisation may also be implemented in response to network or UE requirements.

Example 3GPP Specification Modification

The following is an example of a change to 3GPP TS 38.304 V17.1.0 for adapting a UEs measurement (i.e. selection/reselection) behaviour with respect to Earth-moving NTN and achieving one or more enhancements described above, where the changes are underlined. In particular, the changes set out below take into account the type of service links provided by a cell and those supported by the UE in order to reduce unnecessary measurements on cells. Furthermore, information on cell movement, timings etc. that may be provided to the UE is also used to reduce unnecessary measurements on cells, for example, if coverage of an existing serving cell is not expected to stop within a certain period of time then measurements on neighbouring cells may not be performed, or if coverage of a neighbouring cell is expected to stop within a certain period of time, measurements on this neighbouring cell may not be performed. Furthermore, cell lists and other timing information, assistance information etc. defined above may also be included in the measurement rules for cell re-selection below, such that for example the NTN cells considered are limited to those included on a configured list.

Measurement Rules for Cell Re-Selection

Following rules are used by the UE to limit measurements:
If the serving cell fulfils Srxlev>SIntraSearchP and Squal>SIntraSearchQ:
If distanceThresh is broadcasted in SIB19, and if UE supports location-based measurement initiation and has obtained its location information:
If service link type is Earth-fixed, and
If the distance between UE and the serving cell reference location is shorter than distanceThresh, the UE may not perform intra-frequency measurements;
Otherwise, the UE shall perform intra-frequency measurements;
Otherwise, the UE may not perform intra-frequency measurements;
Otherwise, the UE shall perform intra-frequency measurements.
if service link type is Quasi-Earth-fixed or Earth-moving and the UE is capable of operating in the specific cell type:
If information on serving cell movement (e.g. speed, direction of movement, and/or other) is broadcasted in SIBxx (or as part of satellite ephemeris), and if UE supports coverage-time calculation and has obtained/calculated its time remaining in serving cell coverage (e.g. t-Coverage):
If the tCoverage is larger than timeMeasThresh, the UE may not perform intra-frequency measurements;
Otherwise, the UE shall perform intra-frequency measurements;
Otherwise, the UE may not perform intra-frequency measurements;

- Otherwise, the UE shall perform intra-frequency measurements.
The UE shall apply the following rules for NR inter-frequencies and inter-RAT frequencies which are indicated in system information and for which the has priority provided as defined in 5.2.4.1:
For a NR inter-frequency or inter-RAT frequency with a reselection priority higher than the reselection priority of the current NR frequency, the UE shall perform measurements of higher priority NR infrequency or inter-RAT frequencies according to TS 38.133 [8].
For a NR inter-frequency with an equal or lower reselection priority than the reselection priority of the current NR frequency and for inter-RAT frequency with lower reselection priority than the reselection priority of the current NR frequency:
If the serving cell fulfils Srxlev>SnonIntraSearchP and Squal>SnonIntraSearchQ:
If distanceThresh is broadcasted in SIB19, and if UE supports location-based measurement initiation and has valid UE location information:
If the distance between UE and the serving cell reference location is shorter than distanceThresh, the UE may choose not to perform measurements of NR inter-frequency cells of equal or lower priority, or inter-RAT frequency cells of lower priority;
Otherwise, the UE shall perform measurements of NR inter-frequency cells of equal or lower priority, or inter-RAT frequency cells of lower priority according to TS 38.133 [8];
Otherwise, the UE may choose not to perform measurements of NR inter-frequency cells of equal or lower priority, or inter-RAT frequency cells of lower priority;
Otherwise, the UE shall perform measurements of NR inter-frequency cells of equal or lower priority, or inter-RAT frequency cells of lower priority according to TS 38.133 [8].
If the UE supports relaxed measurement and relaxedMeasurement is present in SIB2, the UE may further relax the measurements, as specified in clause 5.2.4.9.
If service link type is Earth-fixed or Quasi-Earth-fixed:

If the t-Service of the serving cell is present in SIB19, UE shall perform intra-frequency, inter-frequency or inter-RAT measurements before the t-Service, regardless of the distance between UE and the serving cell reference location or whether the serving cell fulfils Srxlev>SIntraSearchP and Squal>SIntraSearchQ, or Srxlev>SnonIntraSearchP and Squal>SnonIntraSearchQ and the time to start measurement before t-Service is up to UE implementation. UE shall perform measurements of higher priority NR inter-frequency or inter-RAT frequencies according to TS 38.133 [8] regardless of the remaining service time of the serving cell (i.e. time remaining until t-Service).

NOTE: When evaluating the distance between LT and the serving cell reference location, it's up to UE implementation to obtain UT location information.

NOTE: For Earth-moving cell, UE should consider the relative velocity between UE and the cell and the relative distance between UE and the cell
If service link type is Earth-moving
If the tCoverage of the serving cell is present in SIB-xx, UE shall follow rules above on measurements, regardless of the t-Service of the serving cell or . . . Otherwise, UE follows same behaviour for the case of Earth-fixed or Quasi-Earth-fixed.

Example NTN Cell Reselection and/or Measurement

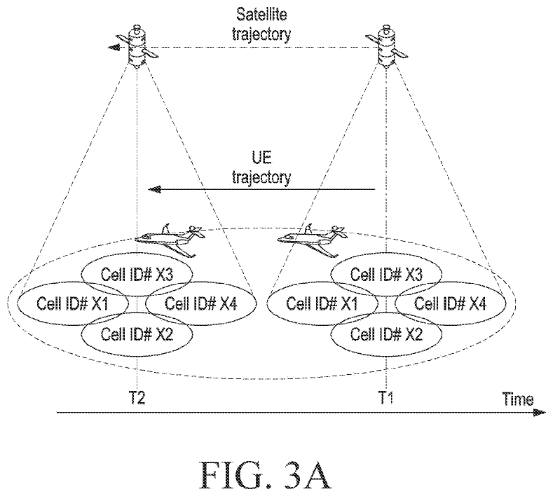

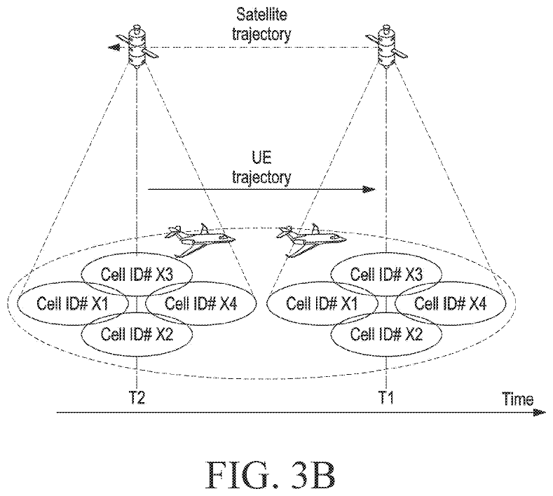

FIGS. 3a and 3b illustrate examples scenarios in which the proposed approaches may be applied, in particular the procedure a UE may perform in view of the Example 3GPP Specification Modification set out above.

In FIG. 3a, the UE and satellite have the same trajectory and in FIG. 3b, the UE and the satellite have different trajectories. In both figures the cells provides by the satellites are earth moving cells, and the UE is positioned on an airplane. Consequently, issues of both earth moving cells and UE mobility are present.

In the scenarios of both FIGS. 3a and 3b, the UE calculates the remaining coverage time for each Earth-moving NTN cell, using received assistance information from the network (e.g. cell speed, cell direction, cell size, cell altitude, cell trajectory, other) and knowledge of its location, speed, altitude, and/or direction of movement, or other parameters related to the UE). The identity of the cells of FIGS. 3a and 3b and their type may be indicated in a received list, the UE may determine the neighboring cells and their type from information received form each neighboring cell, or via information included in broadcast information from one or more cells (e.g. the serving cell). The UE may calculate the cell remaining time in coverage for each cell (relative to the UE) as:

$${t}_{Coverage} [ ms ] ∝ \frac{relative distance}{relative speed}$$

where relativeDistance is the difference between the UE location and location of a reference point/location in the cell and relativeSpeed is the difference between the satellite speed and UE speed. Note the trajectory of the UE, relative to the satellite should be taken into account when calculating the relativeSpeed.

The UE calculates the tCoverage and decides whether to perform measurements and/or cell reselection to each NTN cell. For example, for each NTN cell, the UE compares tCoverage to a given timeMeasThresh. timeMeasThresh is provided by the network to the UE (e.g. broadcasted in a new SIB or existing SIB (e.g. SIB19), or via dedicated signalling/messages).

If the UE receives timeMeasThresh and UE supports time-based measurement for NTN cells, e.g. Earth-moving cell, the UE calculates the tCoverage (as in equation above) for this cell. If remaining time for the cell in coverage is above timeMeasThresh, the UE performs measurements (and/or perform cell (re)selection). Otherwise. UE may not perform measurements (and/or perform cell (re)selection) on this cell.

With specific regard to FIG. 3a, the following approach may be used.

At time T1, the UE (airplane) is served by Earth-moving Cell ID #X1.

UE may perform measurements on neighbour Earth-moving cells for potential cell reselection.

Before performing measurements (and/or perform cell (re)selection), the UE checks whether it has enough time to perform measurements (and/or perform cell (re)selection), considering coverage time for each cell and the UE service link capability (i.e. NTN cell type), and/or other assistance information that the UE may have obtained from the network.

The UE calculates tCoverage at time T2 for Cell ID #X #2, X3, X4:

Cell ID #X2 is expected to have tCoverage<timeMeasThresh, while

Cell ID #X3 and X4 are expected to have tCoverage≥timeMeasThresh.

U may perform measurements and/or cell reselection on either Cell ID #X3 or #Y4.

With specific regard to FIG. 3b, the following approach may be used.

At time T1, the UE (airplane) is served by Earth-moving Cell ID #X1.

UE may perform measurements on neighbour Earth-moving cells for potential cell reselection.

Before performing measurements (and/or perform cell (re)selection)., the UE checks whether it has enough time to perform measurement (and/or perform cell (re)selection)., considering remaining coverage time for each cell and the UE service link capability (i.e. NTN cell type), and/or other assistance information that the UE may have obtained from the NW.

The UE calculates tCoverage for at time T2 for Cell ID #X2, X3, and X4:

Cell ID #X2 and #X3 are expected to have tCoverage<timeMeasThresh.

Cell ID #X4 is expected to have tCoverage≥timeMeasThresh.

The UE decides to perform measurements and/or cell reselection on Cell ID #X4.

A UE which is arranged to operate in accordance with any of the examples of the present disclosure described above includes a transmitter arranged to transmit signals to one or more RANs, including but not limited to a satellite network and a 3GPP RAN such as 5G NR network; a receiver arranged to receive signals from one or more RANs and other UEs; and a controller arranged to control the transmitter and receiver and to perform processing in accordance with the above described methods. The transmitter, receiver, and controller may be separate elements, but any single element or plurality of elements which provide equivalent functionality may be used to implement the examples of the present disclosure described above.

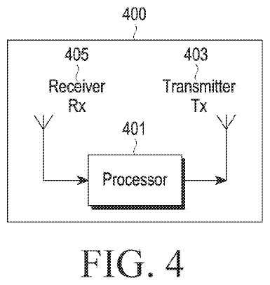

FIG. 4 illustrates a block diagram of an exemplary network entity that may be used in examples of the present disclosure. For example, the UE, entities of the core network or RAN (e.g. eNB, gNB or satellite) may be provided in the form of the network entity illustrated in FIG. 4. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 400 comprises a processor (or controller) 401, a transmitter 403 and a receiver 405. The receiver 405 is configured for receiving one or more messages from one or more other network entities, for example as described above. The transmitter 403 is configured for transmitting one or more messages to one or more other network entities, for example as described above. The processor 401 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

A particular network entity may be implemented as a network element on a dedicated hardware, as a software instance running on a dedicated hardware, and/or as a virtualised function instantiated on an appropriate platform, e.g. on a cloud infrastructure.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers or characteristics described in conjunction with a particular aspect, embodiment or example of the present disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing embodiments. Examples of the present disclosure extend to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

The above embodiments are to be understood as illustrative examples of the present disclosure. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be used without departing from the scope of the invention, which is defined in any accompanying claims.

Further examples in accordance with the present disclosure are set out in the following numbered clauses.
1. A method of a mobile terminal for iron-terrestrial network (NTN) cell in a 5G new radio (NR) mobile communications system, the method comprising
   determining if a NTN cells list has been configured at the mobile terminal; and
   if a NTN cells list has been configured at the mobile terminal, performing NTN cell selection (i.e. cell measurement) based on the NTN cells list.
2. The method of clause 1, wherein the method further comprises transmitting from the mobile terminal to the network (e.g. RAN entity, core network, or other network entity) NTN capability information of the mobile terminal, and wherein the NTN cells list is determined based on the NTN capability information.
3. The method of any preceding clause, wherein the NTN cells list is received by the mobile terminal from the network.
4. The method of any preceding clause, wherein the NTN cells list includes one or more NTN cells the mobile terminal is permitted to perform NTN cell selection based on, or one or more NTN cells the mobile terminal is not permitted to perform NTN cell selection based on.
5. The method of any of clauses 1 to 3, wherein the NTN cells list includes one or more available NTN cells, and the method further includes selecting NTN cells of the available NTN cells on which to perform NTN cell selection based on a service link capability of the mobile terminal and the type of the available NTN cells, and performing NTN cell selection based on the selected NTN cells.
6. The method of any preceding clause, wherein if a NTN cells list has not been configured at the mobile terminal, performing NTN cell selection based on all available NTN cells.
7. The method of any of clauses 1 to 5, wherein, if a NTN cells list has not been configured at the mobile terminal, selecting cells on which to perform NTN cell selection based on a service link capability of the mobile terminal and the type of the available NTN cells, and performing NTN cell selection based on the selected NTN cells.
8. The method of any preceding clause, wherein the method further comprises receiving cell assistance information at the mobile terminal, and selecting cells on which to perform NTN cell selection based on the assistance information.
9. The method of clause 8, wherein the cell assistance information includes information on one or more of cell speed, cell direction, cell size, cell altitude, and cell trajectory of an NTN cell.
10. The method of any preceding clause, wherein the method further includes transmitting to the network mobility information (e.g. velocity, acceleration, trajectory, elevation angle, altitude, and/or other information) of the mobile terminal.
11. The method of clause 10, wherein the method further comprises receiving a request for mobility information of the mobile terminal from the network (e.g. UEInformationRequest message), and transmitting the mobility information (e.g. UEInformationResponse) of the mobile terminal in response to the request.
12. The method of clauses 10 or 11, wherein the NTN cell list is based on the mobility information of the mobile terminal.
13. The method of any preceding clause, wherein the NTN cells are Earth-moving or quasi-Earth-fixed NTN cells.
14. A method of a mobile terminal for non-terrestrial network (NTN) cell selection in a 5G new radio (NR) mobile communications system, the method comprising
   determining a service link type of an available NTN cell, and
if the mobile terminal supports the service link type of the available NTN cell, performing NTN cell selection (i.e. cell measurement) on the available NTN cell.
15. The method of clause 14, wherein the method further comprises determining a remaining coverage time of a serving NTN cell with respect to the mobile terminal, and if the remaining coverage time does not exceed a threshold, performing cell selection based on the available NTN cells.
16. The method of clauses 14 or 15, wherein the method further comprises determining a distance between the mobile terminal and a reference point of a serving NTN cell, and if the distance is equal to or exceeds a threshold, performing cell selection based on the available NTN cell.
17. The method of any of clauses 14 to 16, wherein the service link type of the available NTN cell is Earth-moving or quasi-Earth-fixed.
18. The method of any of clauses 14 to 17, wherein the mobile terminal receives information on a movement of the serving NTN cell, and the coverage time is determined based on the information on a movement of the serving NTN cell.
19. The method of any of clauses 14 to 18, wherein a list of available cells is received from the network.
20. The method of clause 19, wherein the list of available cells includes one or more NTN cells the mobile terminal is permitted to perform NTN cell selection based on, or one or more NTN cells the mobile terminal is not permitted to perform NTN cell selection based on.
21. The method of any preceding clause, wherein the NTN cell selection (e.g. measurement) is based on mobility information of the mobile terminal (e.g. velocity, trajectory, altitude, relative speed to satellite).
22. A mobile terminal for use in a 5G new radio (NR) mobile communications system, the mobile terminal configured to implement the method of any of preceding clause.
23. A method for a network entity of a 5G new radio (NR) mobile communications system, the method comprising
receiving NTN capability information from a mobile terminal,
determining a NTN cell list for the mobile terminal based on the received capability information and service link information of available NTN cells, and
providing the NTN cells list to the mobile terminal.
24. The method of clause 23, wherein the method further comprises receiving mobility information of the mobile terminal from the mobile terminal, and determining the NTN cell list based on the mobility information of the mobile terminal.
25. The method of any preceding clause, wherein the NTN capability information includes information on a NTN capability and/or information on a NTN service link capability of the mobile terminal.
26. A network entity for use in a 5G new radio (NR) mobile communications system, the network entity configured to implement the method of clauses 23 or 24.
27. A method for non-terrestrial network (NTN) cell selection (i.e. measurement) by a mobile terminal in a 5G new radio (NR) mobile communications system, the method comprising
   determining zero or more available NTN cells to perform cell selection upon based on one or more of:
   a NTN cell list received from the network,
   a service link type of the available NTN cells,
   a service link capability of the mobile terminal,
   a coverage time of a serving NTN cell, and
a distance between the mobile terminal and a reference point of the serving NTN cell.
28. A 3GPP mobile communications system configured to implement any of the preceding clauses.
29. A computer readable storage medium having stored thereon computer executable instructions which when executed by a 3GPP mobile communications system cause the 3GPP mobile communications system to perform the method of any of the preceding clauses.

Accordingly, the embodiments herein provide a method of a user equipment (UE) for non-terrestrial network (NTN) the method comprising: receiving, from a network, assistance information related to the non-terrestrial network (NTN) for cell reselection; and performing a measurement on a neighbouring cell for the cell reselection based on the assistance information, wherein the assistance information includes ephemeris information on the neighbouring cell. In the embodiments, the assistance information is included in a system information block (SIB) broadcast by at least one of a serving cell or the neighbouring cell.

In the embodiments, the UE receives, from the network, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Accordingly, the embodiments herein provide a method of a network entity, the method comprising: transmitting, to a user equipment (UE), assistance information related to the non-terrestrial network (NTN) for cell reselection; wherein the assistance information is used to perform a measurement on a neighbouring cell for the cell reselection, and wherein the assistance information includes ephemeris information on the neighbouring cell.

In the embodiments, the assistance information is included in a system information block (SIB) broadcast by at least one of a serving cell or the neighbouring cell.

In the embodiments, the network entity transmits, to the UE, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Accordingly, the embodiments herein provide a user equipment (UE) for non-terrestrial network (NTN), the UE comprising: a transmitter; a receiver; and at least one processor coupled to the transmitter and the receiver, and configured to: receive, from a network, assistance information related to the non-terrestrial network (NTN) for cell reselection, and perform a measurement on a neighbouring cell for the cell reselection based on the assistance information, wherein the assistance information includes ephemeris information on the neighbouring cell.

In the embodiments, the assistance information is included in a system information block (SIB) broadcast by at least one of a serving cell or the neighbouring cell.

In the embodiments, the at least one processor is configured to receive, from the network, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Accordingly, the embodiments herein provide a network entity, the network entity comprising: a transmitter; a receiver; and at least one processor coupled to the transmitter and the receiver, and configured to: transmit, to a user equipment (UE), assistance information related to the non-terrestrial network (NTN) for cell reselection, wherein the assistance information is used to perform a measurement on a neighbouring cell for the cell reselection, and wherein the assistance information includes ephemeris information on the neighbouring cell.

In the embodiments, the assistance information is included in a system information block (SIB) broadcast by at least one of a serving cell or the neighbouring cell.

In the embodiments, the at least one processor is configured to transmit, to the UE, a system information block (SIB), wherein the SIB includes first information on a first type of the neighbouring cell for the measurement on the neighbouring cell, the first type comprising an NTN and a terrestrial network (TN).

In the embodiments, the assistance information includes different information based on a second type of the serving cell, the second type comprising an NTN and a TN. In the embodiments, the SIB includes third information on time for determining when to start the measurement on the neighbouring cell, and fourth information on location for determining when to start the measurement on the neighbouring cell.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of a user equipment (UE) for a non-terrestrial network (NTN), the method comprising:
receiving, from a network, assistance information related to the non-terrestrial network (NTN) for cell reselection; and
performing a measurement on a neighbouring cell for the cell reselection based on the assistance information,
wherein the assistance information includes ephemeris information on the neighbouring cell.

2. The method of claim 1, wherein the assistance information is included in a system information block (SIB) broadcast by at least one of a serving cell or the neighbouring cell.

3. The method of claim 1, further comprising:
receiving, from the network, a system information block (SIB),
wherein the SIB includes first information on a first type of the neighbouring cell for the measurement on the neighbouring cell, the first type comprising an NTN and a terrestrial network (TN).

4. The method of claim 3,
wherein the assistance information includes different information based on a second type of a serving cell, the second type comprising an NTN and a TN.

5. The method of claim 3,
wherein the SIB includes third information on time for determining when to start the measurement on the neighbouring cell, and fourth information on location for determining when to start the measurement on the neighbouring cell.

6. A method of a network entity, the method comprising:
transmitting, to a user equipment (UE), assistance information related to a non-terrestrial network (NTN) for cell reselection;
wherein the assistance information is used to perform a measurement on a neighbouring cell for the cell reselection, and
wherein the assistance information includes ephemeris information on the neighbouring cell.

7. The method of claim 6, wherein the assistance information is included in a system information block (SIB) broadcast by at least one of a serving cell or the neighbouring cell.

8. The method of claim 6, further comprising:
transmitting, to the UE, a system information block (SIB),
wherein the SIB includes first information on a first type of the neighbouring cell for the measurement on the neighbouring cell, the first type comprising an NTN and a terrestrial network (TN).

9. The method of claim 8,
wherein the assistance information includes different information based on a second type of a serving cell, the second type comprising an NTN and a TN.

10. The method of claim 8,
wherein the SIB includes third information on time for determining when to start the measurement on the neighbouring cell, and fourth information on location for determining when to start the measurement on the neighbouring cell.

11. A user equipment (UE) for a non-terrestrial network (NTN), the UE comprising:
a transmitter;
a receiver; and
at least one processor coupled to the transmitter and the receiver, and configured to:
receive, from a network, assistance information related to the non-terrestrial network (NTN) for cell reselection, and
perform a measurement on a neighbouring cell for the cell reselection based on the assistance information,
wherein the assistance information includes ephemeris information on the neighbouring cell.

12. The UE of claim 11, wherein the assistance information is included in a system information block (SIB) broadcast by at least one of a serving cell or the neighbouring cell.

13. The UE of claim 11, wherein the at least one processor is further configured to receive, from the network, a system information block (SIB), and
wherein the SIB includes first information on a first type of the neighbouring cell for the measurement on the neighbouring cell, the first type comprising an NTN and a terrestrial network (TN).

14. The UE of claim 13,
wherein the assistance information includes different information based on a second type of a serving cell, the second type comprising an NTN and a TN.

15. The UE of claim 13,
wherein the SIB includes third information on time for determining when to start the measurement on the neighbouring cell, and fourth information on location for determining when to start the measurement on the neighbouring cell.

16. A network entity, the network entity comprising:
a transmitter;
a receiver; and
at least one processor coupled to the transmitter and the receiver, and configured to:
transmit, to a user equipment (UE), assistance information related to a non-terrestrial network (NTN) for cell reselection,
wherein the assistance information is used to perform a measurement on a neighbouring cell for the cell reselection, and
wherein the assistance information includes ephemeris information on the neighbouring cell.

17. The network entity of claim 16, wherein the assistance information is included in a system information block (SIB) broadcast by at least one of a serving cell or the neighbouring cell.

18. The network entity of claim 16, wherein the at least one processor is further configured to transmit, to the UE, a system information block (SIB), and
wherein the SIB includes first information on a first type of the neighbouring cell for the measurement on the neighbouring cell, the first type comprising an NTN and a terrestrial network (TN).

19. The network entity of claim 18,
wherein the assistance information includes different information based on a second type of a serving cell, the second type comprising an NTN and a TN.

20. The network entity of claim 18,
wherein the SIB includes third information on time for determining when to start the measurement on the neighbouring cell, and fourth information on location for determining when to start the measurement on the neighbouring cell.
